(19) United States
(12) Patent Application Publication
(10) Pub. No.: US 2005/0009611 A1
(43) Pub. Date: Jan. 13, 2005

(54) Simulated cockpit for playing video games

(76) Inventors: Akiyama Masaya, Yokohama (JP); Chin-Yeh Chang, Taichung Hsien (TW)

Correspondence Address: KUO-HSIUNG CHIU, 13F., NO.23, JIUN-HO STREET, PEITUN DISTRICT, TAICHUNG, 406, TW

(21) Appl. No.: 10/614,252

(22) Filed: Jul. 8, 2003

(51) Int. Cl. A63F 13/00

(52) U.S. Cl. 463/46

(57) ABSTRACT

The invention relates to a simulated cockpit for playing video games having a seat assembly, a racing car cockpit simulation assembly and a fighter aircraft cockpit assembly. The seat assembly includes a seat and a coupling tube laterally extended under the seat. The coupling tube contains a threaded hole at the distal end thereof which matches a bolt of a lock element for fastening either a racing car cockpit assembly or a fighter aircraft cockpit assembly in position.

### BACKGROUND OF THE INVENTION

1. Field of the Invention

The invention relates to a simulated cockpit for playing video games, and more particularly, to a simulated cockpit that is easily assembled and specifically suitable for playing video games concerning racing cars or fighter aircraft.

2. Description of the Related Art The video games meant here are specifically designed for PS2 or X-Box type video game player. Due to their perfect simulation to actual situation of car racing and air fighting, they are quite popular for the young people. Even, it's not exaggerated that every of them has one game player. Therefore, many auxiliary apparatuses (game sticks, racing car cockpit assemblies, fighter aircraft cockpit assemblies, etc.) have been developed for the considerable demand of the game players. Referring to FIG. 5, a conventional racing car cockpit assembly 10 in simulation type for the video game player is shown. The racing car cockpit assembly 10 includes a seat 11, a steering wheel assembly 12 and a foot rest 13. At the same time, a steering wheel 14 serves to simulate the actual situation of car racing. Moreover, the seat 11 is adjustable to the height of different users, thereby producing a possibly great comfort in playing games.

However, this kind of racing car cockpit assembly 10 can provide only the simulated situation of car racing. It is not possible for a further application to a simulated fighter aircraft because the flight control apparatuses are located at both side of the player. It's a great pity that the conventional racing car cockpit assembly 10 can't be used for air fighting games which is integrated in the game software. Of course, the players can purchase both racing car cockpit assembly and fighter aircraft cockpit assembly for playing different games whereas many people can't afford it. Besides, this requires double storing space. Consequently, these require to be improved.

### SUMMARY OF THE INVENTION

It is a primary object of the present invention to avoid the drawbacks of the conventional unit and to provide a simulated cockpit for playing video games which combines a racing car cockpit assembly with a fighter aircraft cockpit assembly while they are easily assembled or disassembled for playing different games.

### BRIEF DESCRIPTION OF THE DRAWINGS

The accomplishment of this and other objects of the invention will become apparent from the following description and its accompanying drawings of which:

FIG. 1 is a perspective exploded view of the invention;

FIG. 2 is a perspective view of the invention that is assembled as a racing car cockpit assembly;

FIG. 3 is a perspective view of the invention that is assembled as a fighter aircraft cockpit assembly;

FIG. 4 is a perspective view of the invention showing the adjustment of the seat position; and

FIG. 5 is a perspective view of a conventional racing car cockpit assembly.

### DETAILED DESCRIPTION OF THE PREFERRED EMBODIMENT

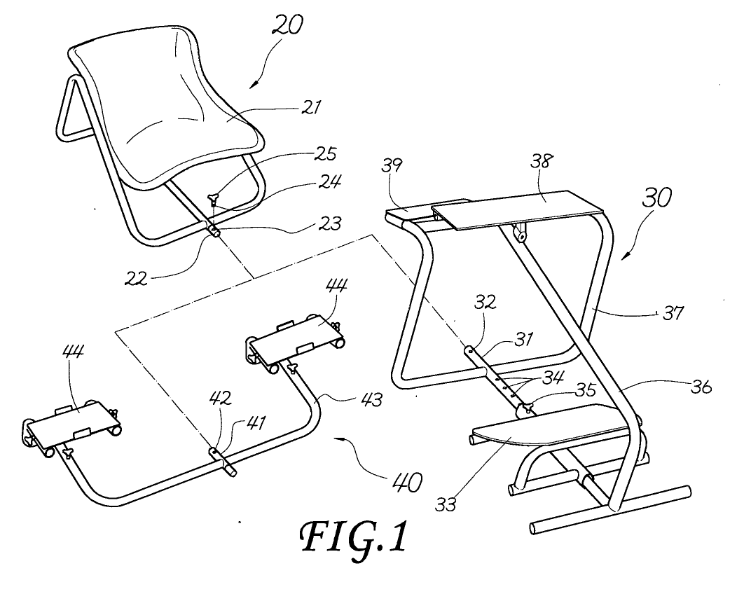

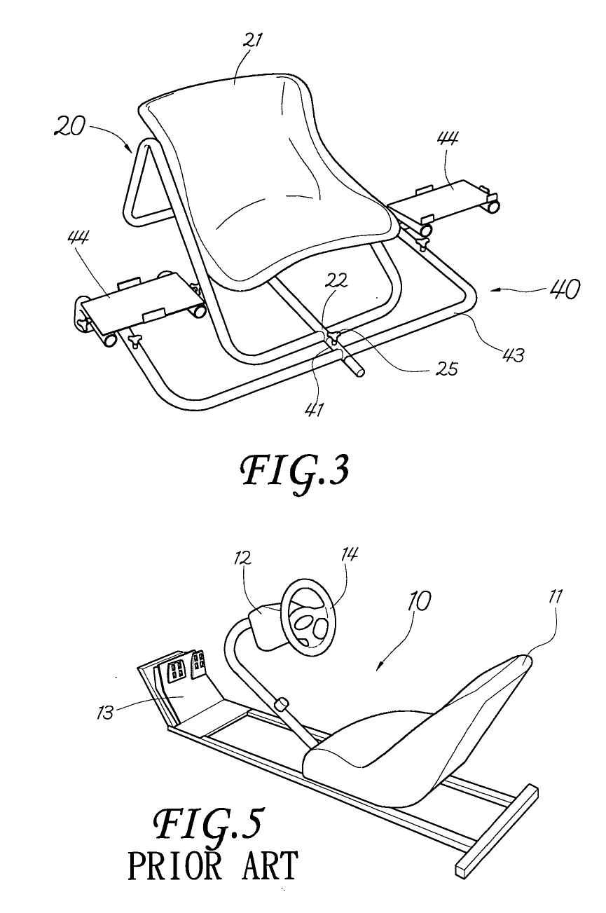

First of all, referring to FIGS. 1 through 3, the simulated cockpit in accordance with the invention includes a seat assembly 20, a racing car cockpit assembly 30 and a fighter aircraft cockpit assembly 40.

The seat assembly 20 has a seat 21 and a coupling tube 22 laterally extended under the seat 21. The coupling tube 22 contains a threaded hole 23 at the distal end thereof which matches a bolt 24 of a lock element 25 for securing either a racing car cockpit assembly 30 or a fighter aircraft cockpit assembly 40 to the seat assembly 20.

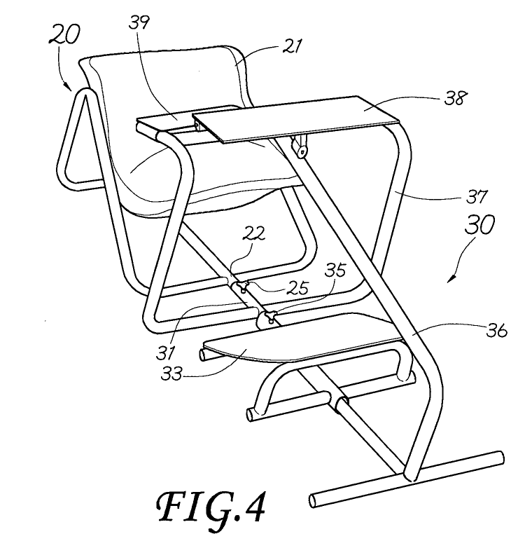

The racing car cockpit assembly 30 has a mounting sleeve 31 corresponding to the coupling tube 22 of the seat assembly 20 and laterally extended on the ground. The mounting sleeve 31 contains a threaded hole 32 in alignment with the threaded hole 23 of the coupling tube 22. The mounting sleeve 31 of the racing car cockpit assembly 30 is mounted on the coupling tube 22 such that the lock element 25 will pass through the threaded holes 32, 23 to join the seat assembly 20 and the racing car cockpit assembly 30 together. Additionally, the mounting sleeve 31 includes a plurality of positioning holes 34 adjacent to the threaded hole 32 at the distal end of the mounting sleeve 31. Furthermore, a further lock element 35 on a foot rest assembly 33 is insertable optionally in any of the positioning holes 34 so that the foot rest assembly 33 is movably received on the mounting sleeve 31 (see FIG. 4). Besides, two supporting tubes 36, 37 are extended upwardly from the front and rear ends of the mounting sleeve 31 for attaching two supporting boards 38, 39 to the supporting tubes 36, 37, respectively. Thus, a steering wheel or a game stick (not shown) for the racing car video game can be placed on the supporting boards 38, 39.

The fighter aircraft cockpit assembly 40 has a coupling sleeve 41 corresponding to the coupling tube 22 of the seat assembly 20 and laterally extended on the ground. The coupling sleeve 41 contains a threaded hole 42 in alignment with the threaded hole 23 of the coupling tube 22. The coupling sleeve 41 of the fighter aircraft cockpit assembly 40 is mounted on the coupling tube 22 in such a manner that the lock element 25 will pass through the threaded holes 42, 23 to join the seat assembly 20 and the fighter aircraft cockpit assembly 40 together. A U-shaped frame 43 is extended in the direction of both sides from the center of the coupling sleeve 41. A supporting board 44 is provided respectively on the end of both arms of the U-shaped frame 43 for placing a game controller (not shown) on the support plate 44.

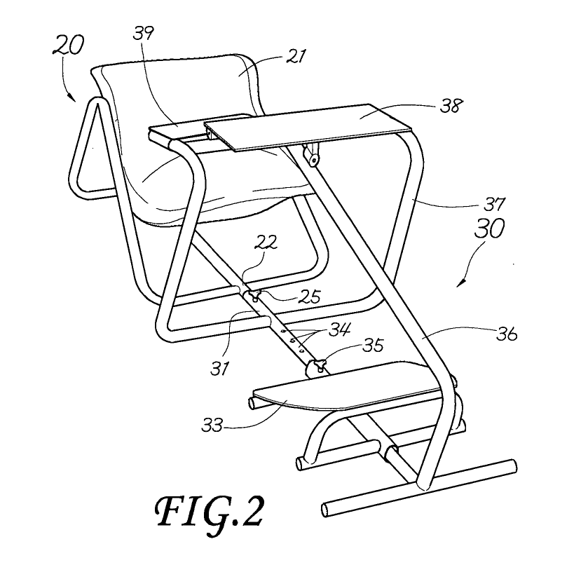

Based upon the above-mentioned, the individual components can be assembled as shown in the FIGS. 2 through 4 to meet different requirements in playing different video games. In other words, the supporting boards 38, 39, 44 of the racing car cockpit assembly 30 and the fighter aircraft cockpit assembly 40 can be easily disassembled and assembled by loosening or tightening the lock element 25 for achieving different application purposes. Moreover, in use of the racing car cockpit assembly 30, the position of the foot rest assembly 33 is adjustable to the height of the user by fitting the further lock element 35 into a desired positioning hole 34.

Many changes and modifications in the above-described embodiment of the invention can, of course, be carried out without departing from the scope thereof Accordingly, to promote the progress in science and the useful arts, the invention is disclosed and is intended to be limited only by the scope of the appended claim.

1. A simulated cockpit for playing video games comprising:
a) a seat assembly having a seat and a coupling tube laterally extended under the seat, the coupling tube having a threaded hole at the distal end thereof which matches a bolt of a lock element for securing either a racing car cockpit assembly or a fighter aircraft cockpit assembly to the seat assembly;
b) a racing car cockpit assembly having a mounting sleeve corresponding to the coupling tube of the seat assembly and laterally extended on the ground, the mounting sleeve having a threaded hole in alignment with the threaded hole of the coupling tube, the mounting sleeve of the racing car cockpit assembly being mounted on the coupling tube of the seat assembly in such a manner that the lock element passes through the threaded holes to join the seat assembly and the racing car cockpit assembly together, the mounting sleeve further having a plurality of positioning holes adjacent to the threaded hole at the distal end of the mounting sleeve, a further lock element on a foot rest assembly is insertable optionally in any of the positioning holes of the mounting sleeve so that the foot rest assembly is movably received on the mounting sleeve, two supporting tubes being extended upwardly from the front and rear ends of the mounting sleeve for attaching two supporting boards to the supporting tubes, respectively, thus placing a steering wheel or a game stick for the racing car video game on the supporting boards; and
c) a fighter aircraft cockpit assembly having a coupling sleeve corresponding to the coupling tube of the seat assembly and laterally extended on the ground, the coupling sleeve having a threaded hole in alignment with the threaded hole of the coupling tube, the coupling sleeve being mounted on the coupling tube in such a manner that the lock element passes through the threaded holes to join the seat assembly and the fighter aircraft cockpit assembly together, a U-shaped frame being extended in the direction of both sides from the center of the coupling sleeve, a supporting board being provided respectively on the end of both arms of the U-shaped frame for placing a game controller on the support plate;
whereby the supporting boards of the racing car cockpit assembly and the fighter aircraft cockpit assembly can be easily disassembled and assembled by loosening or tightening the lock element for achieving different application purposes, and in use of the racing car cockpit assembly, the position of the foot rest assembly is adjustable to the height of the user by fitting the further lock element into a desired positioning hole.
